(19) United States
(12) Patent Application Publication
(10) Pub. No.: US 2015/0049251 A1
(43) Pub. Date: Feb. 19, 2015

(54) PORTABLE COMPUTING DEVICE

(71) Applicant: YENOUKOUME Serge BOKO DAGOUN, Germantown, MD (US)

(72) Inventor: YENOUKOUME Serge BOKO DAGOUN, Germantown, MD (US)

(21) Appl. No.: 14/526,440

(22) Filed: Oct. 28, 2014

(51) Int. Cl. H04N 5/44; G06F 1/16

(52) U.S. Cl. CPC H04N 5/44; G06F 1/1632
USPC 348/729

(57) ABSTRACT

The embodiments herein discloses a portable computing device. The device comprises a main body, a satellite antenna and a cooler fan at a head section of the main body, a web cam built integrally with the satellite antenna, a key board, a mouse pad, a wireless communication module, a plurality of ports, an audio system, a battery power supply and a computer core processor. The satellite antenna is configured to connect the computing device to any satellite television channel or radio station to allow a user to view and listen a desired satellite television channel or a radio channel. The core processor is connected to an external display device through wired and wireless connection for data transmission. The external display device is any one of a LED television, flat screen monitor, HDTV, Television monitor, and computer screen.

### CROSS REFERENCE TO RELATED APPLICATION

The present application claims the priority of the U.S. Provisional Patent Application with Ser. No. 61/897843 filed on Oct. 31, 2013 and the content of which is incorporated in entirety by reference herein.

### BACKGROUND

1. Technical Field

The embodiments herein generally relate to a computing device. The embodiments herein particularly relate to a portable computing device. The embodiments herein more particularly relate to a portable computing device adopted to connect to an external monitor screen or television screen.

2. Description of the Related Art

A portable desktop allows a user to utilize hardware of a host computer system and thus provides a portable computing environment. A portable desktop may be physically embodied in a portable storage media and more often is embodied in a portable device which includes processing hardware, storage, and input/output (I/O) hardware for communication with the host system and/or authentication by a user. Portability, therefore, depends upon the ability of the portable desktop device to function with as many host computer systems as possible and independent of the software, operating system (O/S), or particular hardware possessed by the host computer systems. Depending upon the use of the portable desktop device, different considerations have become more or less important in its configuration and capability.

In the view of the foregoing, there is a need for a computer without screen and which comprise a plurality of components for online navigation through connection of flat screen desktop, flat screen television, and monitor screen. Further, there is need for a low cost computing device which combines a portability of a laptop computer with the capability of a desktop computer. Also, there is a need for a compact, space saving, light weight computing device unit that is connected to various computer monitor screens and as well as TV screens.

The above mentioned shortcomings, disadvantages and problems are addressed herein and which will be understood by reading and studying the following specification.

### OBJECTIVES OF THE EMBODIMENTS HEREIN

The primary object of the embodiments herein is to provide a portable desktop computer device without a display screen and which is wired/wirelessly connected to any kind of television (TV) monitor and desktop monitor.

Another object of the embodiments herein is to provide for a compact, space saving, light weight computing device by combining a portability of a laptop computer with a capability of a desktop computer.

Yet another object of the embodiments herein is to provide a computer with satellite antenna to enable users or subscribers to access and capture satellite channels and radio stations.

Yet another object of the embodiments herein is to provide a portable computing device without screen and with improved speed and processing capacity by upgrading memory ram extension of the computing device and by providing a fan of large cooling capacity.

Yet another object of the embodiments herein is to provide a portable computing device without screen to enable the users to connect directly and instantly to internet using a WI-FI feature embedded in the device.

Yet another object of the embodiments herein is to provide a portable computing device with a built-in keyboard in which all the keyboard functions are enabled.

Yet another object of the embodiments herein is to provide a portable computing device with a built-in mouse in which all the mouse functions are enabled.

These and other objects and advantages of the present invention will become readily apparent from the following detailed description taken in conjunction with the accompanying drawings.

### SUMMARY

The various embodiments herein provide a portable computing device. The device comprises a main body, a satellite antenna provided at a head section of the main body, a cooler fan arranged at the head section of the main body, a web cam built integrally with the satellite antenna, a key board, a mouse pad, a wireless communication module, a plurality of ports, an audio system arranged in the main body, a battery power supply and a computer core processor. The satellite antenna is configured to connect the computing device to any available satellite television channel to allow a user to view a desired satellite television channel. The plurality of ports comprises a Universal Serial Bus (USB) composite port, USB port, Video Graphics Adaptor (VGA) monitor port, Local Area Network (LAN) connector jack, telephone jack, media control port, media output port, parallel port, S-VIDEO and i-link port, High Definition Multimedia Interface (HDMI) port, PC and SD card slot, a game port and a power adopter port. The core processor is connected to an external display device through wired and wireless connection to transmit a data for display. The external display device is selected from a group consisting of a Light Emitting Diode (LED) television, flat screen monitor, High Definition TV (HDTV), Television monitor, and computer screen.

According to an embodiment herein, the device comprises a CD/RW/DVD/BLUE RAY DISK drive and player, a power switch button, a power supply adapter and a USB transmitter.

According to an embodiment herein, the satellite antenna is configured to select any television channel or radio station to view and listen and desired television channel or radio channel.

According to an embodiment herein, the device is connected to the display device through wireless communication module.

According to an embodiment herein, the wireless communication module is configured to provide instant internet connectivity.

According to an embodiment herein, the VGA port is configured to connect the device to LED TV or any display device.

According to an embodiment herein, the key board is a full function key board or a full function touch pad.

According to an embodiment herein, the audio system is a Dolby system or a home theater system.

According to an embodiment herein, the USB transmitter is used to transmit data to the display device provided with a receiver for projecting a display.

According to an embodiment herein, the VGA port is configured to transmit data to the display device not provided with data receiver.

According to an embodiment herein, the device further comprises an air blower and a mini fan.

According to an embodiment herein, the i-link is an IEEE 1394 port.

According to an embodiment herein, the satellite antenna is a movable antenna and wherein the satellite antenna is moved to left or right hand sides of the device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a front view of a portable computing device without a display screen, according to an embodiment herein.

FIG. 2 illustrates a top side view of the portable computing device without the display screen, according to an embodiment herein.

FIG. 3 illustrates a functional block diagram of wireless communication system in the portable computing device for establishing a wireless connectivity between the computing device and the external display device, according to an embodiment herein.

FIG. 4 illustrates a functional block diagram of wired communication system in the portable computing device for establishing a wired connectivity between the computing device and the external display device, according to an embodiment.

Although the specific features of the embodiments herein are shown in some drawings and not in others, this is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a portable computing device. The device comprises a main body, a satellite antenna provided at a head section of the main body, a cooler fan arranged at the head section of the main body, a web cam built integrally with the satellite antenna, a key board, a mouse pad, a wireless communication module, a plurality of ports, an audio system arranged in the main body, a battery power supply and a computer core processor. The satellite antenna is configured to connect the computing device to any available satellite television channel to allow a user to view a desired satellite television channel. The plurality of ports comprises a Universal Serial Bus (USB) composite port, USB port, Video Graphics Adaptor (VGA) monitor port, Local Area Network (LAN) connector jack, telephone jack, media control port, media output port, parallel port, S-VIDEO and i-link port, High Definition Multimedia Interface (HDMI) port, PC and SD card slot, a game port and a power adopter port. The core processor is connected to an external display device through wired and wireless connection to transmit a data for display. The external display device is selected from a group consisting of a Light Emitting Diode (LED) television, flat screen monitor, High Definition TV (HDTV), Television monitor, and computer screen.

According to an embodiment herein, the device comprises a CD/RW/DVD/BLUE RAY DISK drive and player, a power switch button, a power supply adapter and a USB transmitter.

According to an embodiment herein, the satellite antenna is configured to select any television channel or radio station to view and listen and desired television channel or radio channel.

According to an embodiment herein, the device is connected to the display device through wireless communication module.

According to an embodiment herein, the wireless communication module is configured to provide instant internet connectivity.

According to an embodiment herein, the VGA port is configured to connect the device to LED TV or any display device.

According to an embodiment herein, the key board is a full function key board or a full function touch pad.

According to an embodiment herein, the audio system is a Dolby system or a home theater system.

According to an embodiment herein, the USB transmitter is used to transmit data to the display device provided with a receiver for projecting a display.

According to an embodiment herein, the VGA port is configured to transmit data to the display device not provided with data receiver.

According to an embodiment herein, the device further comprises an air blower and a mini fan.

According to an embodiment herein, the i-link is an IEEE 1394 port.

According to an embodiment herein, the satellite antenna is a movable antenna and wherein the satellite antenna is moved to left or right hand sides of the device.

The embodiments herein provide a portable computing device without a display screen. The device is connected to an external device for displaying information from the computing device. The computing device has a compact and light-weight design as the monitor or display screen is eliminated from the device. The computing device is easily connectable to any computer monitor or Television screen. The computing device is configured to serve for residential, office and school use.

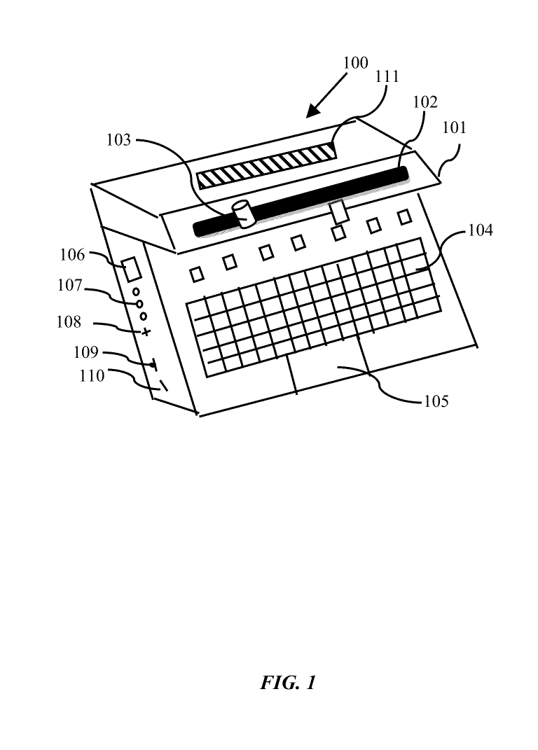

FIG. 1 illustrates a front view of a portable computing device without a display screen, according to an embodiment herein. With respect to FIG. 1, the device 100 comprises a main body 101, a satellite antenna 102 provided at a head section of the main body 101, a cooler fan arranged at the head section of the main body 101, a web cam 103 built integrally with the satellite antenna 102, a key board 104, a mouse pad 105, a wireless communication module, a plurality of ports, an audio system arranged in the main body, a battery power supply 111 and a computer core processor. The satellite antenna 102 is configured to connect the computing device 100 to any available satellite television channel to allow a user to view a desired satellite television channel. The device 100 has the built-in keyboard 104 comprising a plurality of keyboard functionalities. Depending on the configuration of the computing device, an analog or digital keyboard is used. The device 100 further comprises the built-in mouse 105 adopting a plurality of mouse functions. Thereby no extra mouse is needed. However, the users are allowed to use an external mouse or an external keyboard if they choose to.

The device also uses a built-in Wi-Fi which allows the users to provide a direct internet connection and legal broadband connection. With the Wi-Fi module, the users are able to connect directly to internet since the Wi-Fi feature is enabled. The internet connects to the device through LAN device. The portable device is built with a Wireless Internal Card that allows the instant connection to a plurality of wireless routers. The wireless card is inserted into a slot on top of a motherboard. At a single press of a button, the wireless function is enabled or activated.

The plurality of ports comprises a USB composite port 110, VGA monitor port 106, LAN connector jack, telephone jack, media control port, media output port, parallel port, S-VIDEO and i-link port 108, HDMI port 109, audio ports 107, PC and SD card slot, game port and power adapter port. The device with built in USB plugs 110 enables the data saving process, card reading, printing features and other USB features. The VGA port 106 is one of the important output ports for the computing device. A VGA cord provides the wired connection from the computing device to the external display device through the VGA port 106 provided on both the devices. The parallel port is another important communication port on the device which is used by the users for connecting various peripheral devices such as printers to the computing device. The S-Video and i-link (IEEE1394) port 108 is a video input port for connecting cameras, camcorders and any video connection. The users are allowed to access the photos and videos through insertion of SD card into the SD slot provided in the device.

The core processor is connected to an external display device through wired and wireless connection to transmit data for display. The external display device is selected from a group consisting of a LED television, flat screen monitor, HDTV, Television monitor and computer screen. The device is connected to the display device through wireless communication module. The wireless communication module is configured to provide instant internet connectivity.

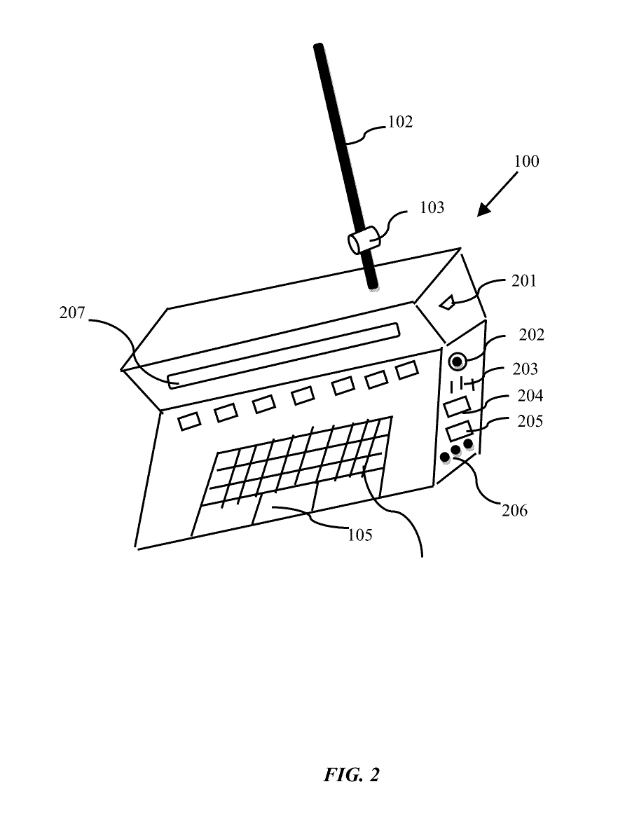

FIG. 2 illustrates a top side view of the portable computing device without the display screen, according to an embodiment herein. According to FIG. 2, the satellite antenna 102 along with the webcam 103 is connected to the main body of the computing device 100. The primary function of the satellite antenna 102 is to enable the computing device 100 to connect to the available satellite channel and allow the users to watch channels on the external display device connected to the computing device 100. The satellite antenna 102 is built with the webcam 103 and a tip on the top of the antenna is configured to capture magnetic signalization from a plurality of routers so as to access the plurality of satellite channels or available air channels. The antenna tip further provides a medium to wirelessly connect the computing device and the external display devices to the internet via a router. The antenna eliminates a need for a VGA cord to connect the computing device to the external display device.

According to FIG. 2, the computing device with the built-in webcam 103 provides a plurality of multi-angled webcam features. The webcam 103 comprising the antenna tip enables the user to watch TV upon contracts. The webcam 103 is a small device that is connected to the computing device 100 to allow the users to record live video. The webcam 103 also assist the users in live conferencing from a place A to another place B or on a tri-way sharing a live video. The videos from a webcam are recorded and send to a media or to be kept for personal souvenir. The recorded videos are also displayed on the external display device connected to the computing device.

The device further comprises a CD/RW/DVD/BLUE RAY DISK drive and player, a power switch button 201, a power supply adapter 202 and a USB transmitter port 203. The device is equipped with the plurality of game ports 206 allowing the users to play game on the device. Just like the regular laptop, the computing device receives a power supply through an AC adapter 202 and power cord. Specifically, the device further comprises a built-in Dolby home theater system 207 with a plurality of speakers which enable a high quality and synthetic sounds. The device uses a phone port (RJ-11) 204 and internet connection port (RJ-45) 205.

The fan cooler inside the computing device is larger than the fan used in regular laptop so as to allow more efficient cooling system. The fan cooler is configured to supply air to the entire computing device, thereby allowing the device to cool down and to prevent from overheating of the system. The design and a functioning of the cooling fan or air blower is selected according to the shape of the computing device. The well designed and powerful fan with a typical size little larger than the regular fan found in the present computer system allows an efficient communication and the ventilation, thereby preventing an unexpected shooting down and overheating of the computing device.

The computing device is connected to the external display device using one of at least two communication way systems. The computer device is either wirelessly connected with the external monitors such as LED Televisions or LED computer monitors which exhibit wireless ability. The communication between the computing device and the external screen is also made by the VGA cable. The cable is connected between the external screen and computing device having through the VGA port access.

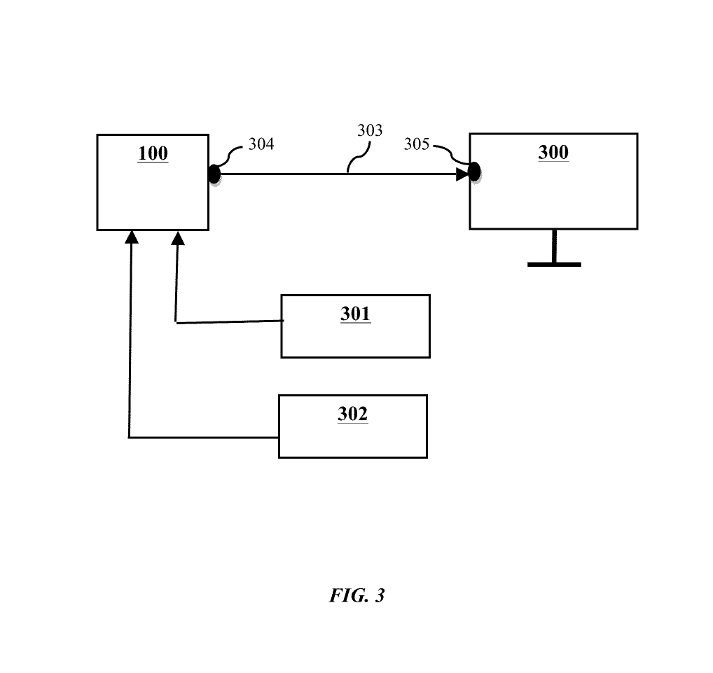

FIG. 3 illustrates a functional block diagram of wireless communication system in the portable computing device for establishing a wireless connectivity between the computing device and the external display device, according to an embodiment herein. In case of wired connectivity, the computing device 100 is connected using the VGA cable 303 from the computing device 100 VGA port 304 to the main VGA port 305 of the LED Television or the LED Monitor, HDTV and/or to the regular computer flat monitor screen 300. In case of the wireless connection, the communication protocol enables internet connectivity on the computing device depending on the user. The user is allowed to activate/deactivate the wireless connection from the router 301 or the user is allowed to simply use the LAN connection 302. The length of VGA cable 303 depends on the distance between the computing device and the external display device 300. The size of the VGA cable 303 further depends on a need of the user. The same connection is done through the HDMI output from the computing device to the HDMI input of the display device.

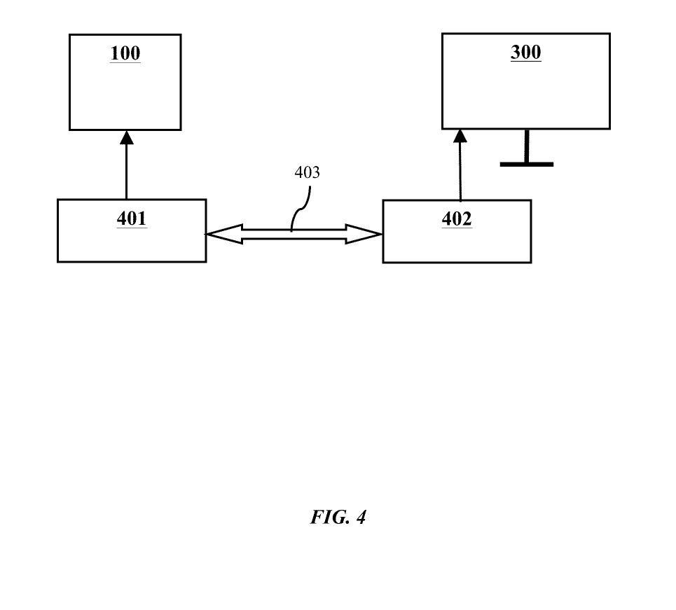

FIG. 4 illustrates a functional block diagram of wired communication system in the portable computing device for establishing a wired connectivity between the computing device and the external display device, according to an embodiment. In case of a wireless connection 403, a USB transmitter 401 and a data receiver module 402 is adopted for establishing the connectivity. The USB transmitter 401 is inserted inside the USB port of computing device 100 and the data receiver module 402 is connected to the USB Port of the external display device 300. The wireless connection 403 between the USB transmitter 401 and the data receiver module 402 enables an exchange/transmission of the data from the computing device 100 to the display device 300. The data receiver 402 is recognized once the receiver software is installed on the computing device 100. Since the receiver 402 is connected to the external display device 300, the information from the computing device 100 is instantly displayed on the screen.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A portable computing device comprising:
a main body:
a satellite antenna provided at a head section of the main body, and wherein the satellite antenna is configured to connect the computing device to any available satellite television channel to allow a user to view a desired satellite television channel;
a web cam built integrally with the satellite antenna;
a key board;
a mouse pad;
a wireless communication module;
a plurality of ports, and wherein the plurality of ports comprises a USB composite port, USB port, VGA monitor port, LAN connector jack, telephone jack, media control port, media output port, parallel port, S-VIDEO and i-link port, HDMI port, PC and SD card slot, game port and power adopter port;
a cooler fan arranged at the head section of the main body;
an audio system arranged in the main body;
a battery power supply;
a computer core processor:
wherein the core processor is connected to an external display device through wired and wireless connection to transmit data for display, and wherein the external display device is selected from a group consisting of a LED television, flat screen monitor, HDTV, Television monitor, and computer screen.

2. The device according to claim 1 further comprises a CD/RW/DVD/BLUE RAY DISK drive and player, a power switch button, a power supply adapter and a USB transmitter.

3. The device according to claim 1, wherein the satellite antenna is configured to select any television channel or radio station to view and listen and desired television channel or radio channel.

4. The device according to claim 1, wherein the device is connected to the display device through wireless communication module.

5. The device according to claim 1, wherein the wireless communication module is configured to provide instant internet connectivity.

6. The device according to claim 1, wherein the VGA port is configured to connect the device to LED TV or any display device.

7. The device according to claim 1, wherein the key board is a full function key board or a full function touch pad.

8. The device according to claim 1, wherein the audio system is a Dolby system or a home theater system.

9. The device according to claim 2, wherein the USB transmitter is used to transmit data to the display device provided with a receiver for projecting a display.

10. The device according to claim 1, wherein the VGA port is configured to transmit data to the display device not provided with data receiver.

11. The device according to claim 1 further comprises an air blower and a mini fan.

12. The device according to claim 1, wherein the i-link is an IEEE 1394 port.

13. The device according to claim 1, wherein the satellite antenna is a movable antenna and wherein the satellite antenna is moved to left or right hand sides of the device.
